(19) United States
(12) Patent Application Publication
(10) Pub. No.: US 2008/0096565 A1
(43) Pub. Date: Apr. 24, 2008

(54) Methods and circuits for roaming between different networks

(75) Inventors: Xiaohui Jin, Shanghai (CN); Xiaoling Shao, Shanghai (CN); Lei Feng, Shanghai (CN); Bo Liu, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,670

(22) PCT Filed: Jul. 4, 2005
(86) PCT No.: PCT/IB05/52209

§ 371 Date: Jan. 5, 2007

(30) Foreign Application Priority Data
Jul. 9, 2004 (CN) 200410063638.6

(51) Int. Cl. H04Q 7/20

(52) U.S. Cl. 455/437

(57) ABSTRACT

The present invention takes the advantage of the wireless local area network (WLAN) resources in hotspots for voice and data connections and enables seamless handover between wireless wide area network (WWAN) and WLAN and vice versa, thus achieving cost savings for the end users and WWAN resources savings for the wireless operators. According to one embodiment of the invention, a mobile terminal having WWAN and WLAN interfaces establishes a WWAN call with a called mobile terminal via a WWAN. If a WLAN is present, the mobile terminal sends a handover request together with its network address to the called mobile terminal, using a short message service (SMS) technique or a watermarking technique, for initiating a WLAN call with the called mobile terminal via a WLAN. After the WLAN call is established with the called mobile terminal, the mobile terminal releases the WWAN call.

### FIELD OF THE INVENTION

The invention relates to methods and circuits for seamlessly roaming between a first wireless communication network and a second wireless communication network.

### BACKGROUND OF THE INVENTION

FIG. 1 illustrates typical service areas in which mobile terminals such as mobile phones are used. In these areas, the WWAN service area (e.g., GSM, GPRS, CDMA, 3G) may or may not overlap with a WLAN service area (as shown in FIG. 1). In the case where there is an overlap between the WWAN and WLAN service areas, both the WWAN and WLAN services are available. These overlapping areas are also referred to as hotspots, which include airports, hotels, office buildings and home environment.

In hotspots (e.g., airports and hotels), people normally use mobile terminals for making voice calls and using low-speed data services via the WWAN and for using high-speed data services via the WLAN through access points (APs). In situations in which two mobile terminals in the same hotspot or in different hotspots run by the same service provider are trying to communicate with each other, they still need to use the WWAN service to make voice calls. This is not cost effective even though a low cost alternative communication network, i.e., the WLAN, is available to both parties.

US Patent application with the Pub. No. 2002/0085516 A1 discloses system and method for automatic and seamless vertical roaming (SVR) between a wireless local area network (WLAN) and a wireless wide area network (WWAN) while maintaining an active voice or data communication. However, US 2002/0085516 A1 only focuses on network infrastructure, and no structure and method for terminals are provided to achieve such roaming.

### SUMMARY OF THE INVENTION

Therefore, the object of the invention is to provide methods and circuits with effective cost for seamlessly roaming between a first wireless communication network and a second wireless communication network in areas in which both services are available.

To achieve this object, a first aspect of the invention provides a method performed by a calling mobile terminal having at least dual radio interfaces respectively for a first wireless communication network and a second wireless communication network. The method comprises the steps of detecting presence of the first and second wireless communication networks and sending a handover request to a called mobile terminal for initiating a second communication via the second wireless communication network, if the second wireless communication network is present. When a response from the called mobile terminal indicates an acceptance of the handover request, a step of establishing the second connection with the called mobile terminal via the second wireless communication network is performed. Due to roaming to the second wireless communication network, which could have a cheaper billing system, the method has the advantage that end users can save communication cost and operator of the first wireless communication network can save network resource.

In an embodiment in accordance with the invention, the method performed by the calling mobile terminal may reestablish a connection with the called mobile terminal via the first wireless communication network for maintaining communication, when the calling mobile terminal is moving away from the second wireless communication network. Such a method has the advantage that a continuous communication is ensured and a seamless handover is achieved.

In another embodiment in accordance with the invention, the method performed by the calling mobile terminal may perform the step of sending the handover request according to the preferred radio interface based on the user profile in the calling mobile terminal. Such a method has the advantage that the user of the calling mobile terminal has more flexible choices for the handover, because the user may set the calling mobile terminal to handover automatically or manually.

In another embodiment in accordance with the invention, the method performed by the calling mobile terminal may send the extra information via the voice channel. Since the extra information is sent via a conventional channel, such a method has the advantage that no additional channel resource is required.

In another embodiment in accordance with the invention, the method performed by the calling mobile terminal may send the extra information together with the input voice. Since the extra information may be sent via the voice channel at any time during communication, such a method has the advantage that the extra information may be sent immediately regardless whether the user is talking or not.

In another embodiment in accordance with the invention, the method performed by the calling mobile terminal may multiplex the extra information in DTMF-like signal form with input voice and output the combined signals. Since DTMF is a kind of watermarking technology, such a method has the advantage that in the combined signals, the extra information in DTMF-like signal form cannot be imitated by the input voice.

A second aspect of the invention provides a method performed by a called mobile terminal having at least dual radio interfaces respectively for a first wireless communication network and a second wireless communication network. The method comprises the steps of detecting whether the second wireless communication network is present, if receiving extra information including a handover request from the calling mobile terminal for initiating a second connection via the second wireless communication network sending a response to the calling mobile terminal with an acceptance of the handover request if the second wireless communication network is present and

accepting the second connection with the calling mobile terminal. Correspondingly, this method also provides cheaper communication and network resource saving.

In another embodiment in accordance with the invention, the method performed by the called mobile terminal may reestablish a connection with the called mobile terminal via the first wireless communication network for maintaining communication, when the called mobile terminal is moving away from the second wireless communication network. Correspondingly, such a method also has the advantage that a continuous communication is ensured and a seamless handover is achieved.

In another embodiment in accordance with the invention, the method performed by the called mobile terminal may perform the step of sending a response with an acceptance of the handover request according to the preferred radio interface of the called mobile terminal. Correspondingly, such a method also has the advantage that the user of the called mobile terminal has more flexible choices for the handover.

In another embodiment in accordance with the invention, the method performed by the called mobile terminal may comprise the step of demultiplexing DTMF-like signal from the combined signals and demodulating the extra information from the DTMF-like signal. The extra information can be decoded to original extras information, so such a method has the advantage that the extra information may be received in the voice channel together with the voice signal.

Other aspects of the invention provide a circuit including a plurality of means for performing the method performed by the calling mobile terminal, a circuit including a plurality of means for performing the method performed by the called mobile terminal, a computer program product for handover of the calling mobile terminal, and a computer program product for handover of the called mobile terminal,

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates typical service areas in which mobile terminals are used;

FIG. 2 shows a basic architecture of a mobile terminal with dual radio interfaces;

FIG. 3 illustrates a method for seamlessly roaming between a WWAN and a WLAN;

FIG. 4 shows a circuit for adding extra information as analog signals in a calling mobile terminal, in accordance with one embodiment of the invention;

FIG. 5 shows a circuit for demodulating the extra information added as analog signals in a called mobile terminal, in accordance with one embodiment of the invention;

FIG. 6 shows a circuit for adding the extra information as digital signals in a calling mobile terminal, in accordance with one embodiment of the invention;

FIG. 7 shows a circuit for extracting the extra information inserted as digital signals in a called mobile terminal, in accordance with one embodiment of the invention;

FIG. 8 shows a circuit for adding extra information as analog signals in a calling mobile terminal, in accordance with another embodiment of the invention;

FIG. 9 shows a circuit for demodulating the extra information added as analog signals in a called mobile terminal, in accordance with another embodiment of the invention;

FIG. 10 shows a circuit for adding the extra information as digital signals in a calling mobile terminal, in accordance with another embodiment of the invention; and

FIG. 11 shows a circuit for extracting the extra information inserted as digital signals in a called mobile terminal, in accordance with another embodiment of the invention.

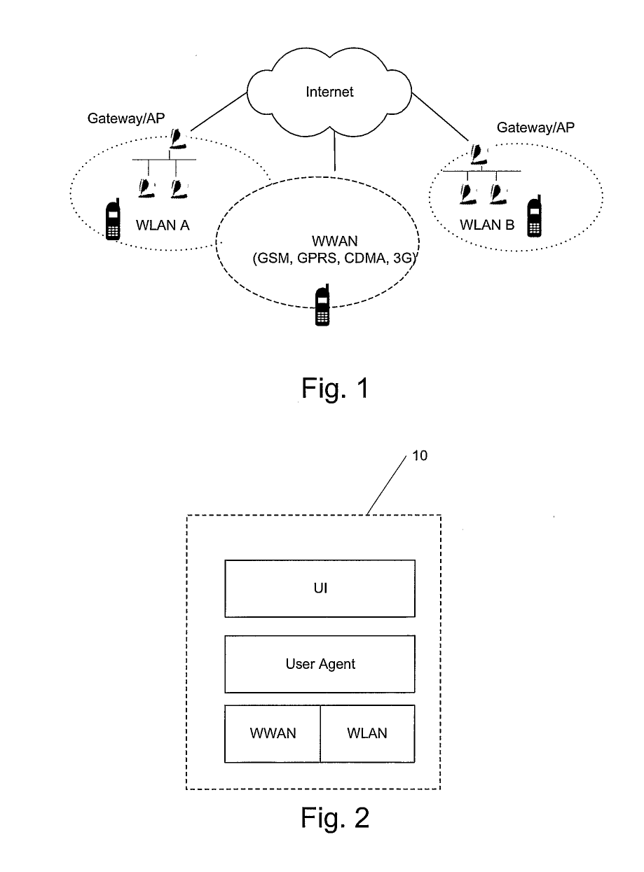

Throughout the drawings, the same reference numerals indicate similar or corresponding features or functions.

### DETAILED DESCRIPTION OF THE PREFERRED EMBODIMENTS

FIG. 2 shows a basic architecture of a mobile terminal 10 with dual radio interfaces—WWAN and WLAN interfaces—for use in the invention. When a user tries to make a call with mobile terminal 10, a user agent, which is responsible for profile management, service mediation, etc., will first make a WWAN call. After the call is set up, the user agent will determine which radio interface to use based on the user profile and the available radio interfaces. The user profile contains information about the radio interface preferences, handover permission during an active connection, etc. For example, if the user prefers a connection via the WLAN interface, the user agent will, after setting up the WWAN call, try to connect both parties via a WLAN. After the WLAN call (e.g., a voice or video call) is successfully set up, the WWAN call will be released without the user's direct involvement.

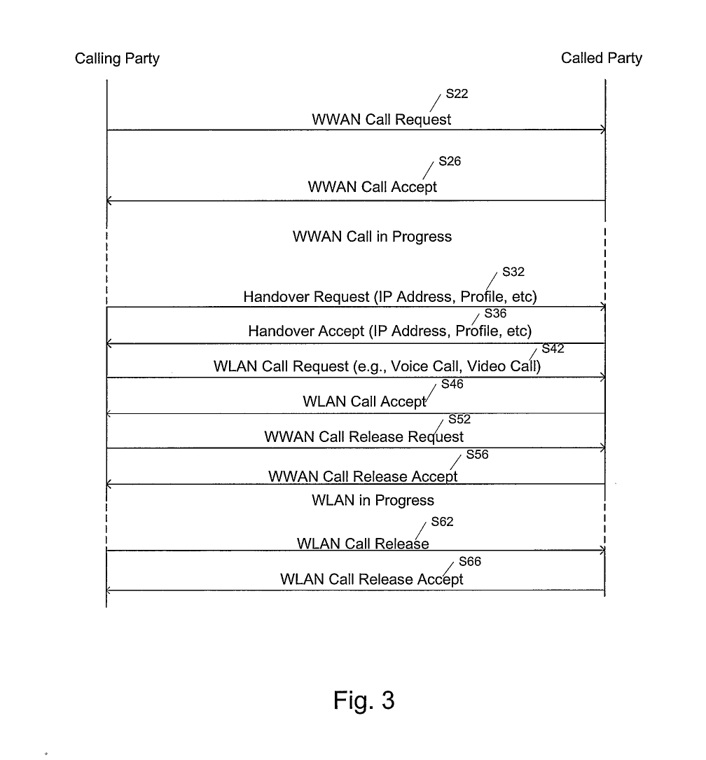

FIG. 3 illustrates a method 20 for seamlessly roaming between a WWAN and a WLAN, according to one embodiment of the invention. When a party enters into a hotspot, the user agent of this party's mobile terminal will detect the types of wireless services available. When the party tries to make a call, the user agent of this calling party's mobile terminal will make a call via a WWAN in a conventional way, using the MSISDN (Mobile Station International ISDN Number) of a called mobile terminal (steps S22 and S26). After the WWAN call is properly set up, the user agent of the calling mobile terminal will decide which radio interface to use based on the user profile of the calling party. If a WLAN is preferred, and the WLAN interface is available, the user agent will send extra information including a handover request together with information about the IP address, user profile, etc. of the calling mobile terminal to the called mobile terminal for handing over the call to the WLAN (step S32). The extra information is transferred using the short message service (SMS) or the watermarking technology. The watermarking technology allows the extra information to be hidden within the voice, as will be described later.

Upon receiving the handover request, the user agent of the called mobile terminal will decide whether to accept the request, based on its own user profile and the available radio interface of the called mobile terminal. If the called mobile terminal agrees to hand over the call to the WLAN, its user agent will send similar extra information including a handover accept response together with information about the IP address, user profile, etc. of the called mobile terminal to the calling mobile terminal, using the SMS or the watermarking technology (step S36). The calling mobile terminal will then initiate a call (e.g., a voice or video call) via a WLAN, using the received IP address of the called mobile terminal (steps S42 and S46). When the WLAN call has been successfully set up, the WWAN call may be released (steps S52 and S56). After the WLAN call is completed, it will also be released (steps S62 and S66).

In the above, during an active WLAN call, one of the parties may leave a WLAN service area. In such case, the user agent of this party's mobile terminal will recognize a change in the radio signals. If the calling party is leaving the area, the user agent of the calling mobile terminal will try to initiate a new WWAN call to the called mobile terminal. On the other hand, if the called party is leaving the area, the user agent of the called mobile terminal will send a handover request via the WLAN to the calling mobile terminal to initiate a new WWAN call. This new WWAN call will be automatically accepted by the called mobile terminal. After the new WWAN call is successfully set up, the WLAN call will be immediately released by both parties. Optionally, the called mobile terminal may also initiate the new WWAN call to the calling mobile terminal when the called party is leaving the area.

In the above, the handovers from a WWAN to a WLAN and vice versa are transparent to both users, so that the talk between them is not affected. Also, the parties may communicate with each other via two WLAN networks, within each of which one party is present, that are connected via Internet.

The watermarking technology as used in the invention will now be described. By using this technology, the extra information (i.e., the handover request, IP address, user profile, etc.) is exchanged along with the voice in one channel, e.g., the voice channel between two mobile terminals. Such exchanges will not affect the normal voice conversation, since during a typical telephone conversation, 50% of the time is used for listening and 10% of the time is used for pausing between words and sentences. Therefore, there are sufficient resources for exchanging the extra information, without requiring modifications to the existing network infrastructure. The extra information may be added by the user agent in a mobile terminal as either analog signals or digital signals.

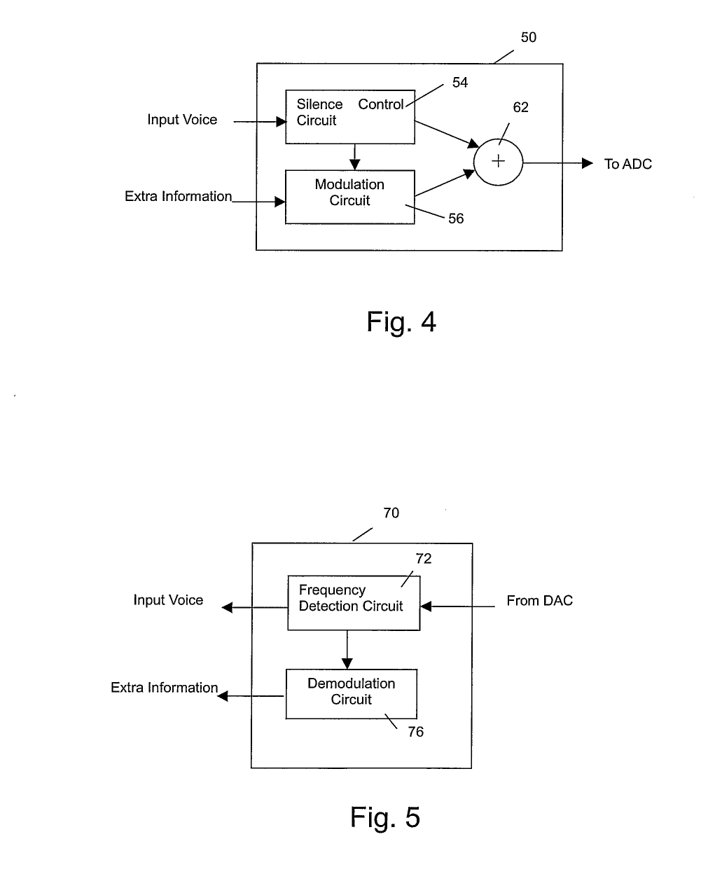

FIG. 4 shows a circuit 50 for adding the extra information (i.e., the handover request, IP address, user's profile, etc.) in the voice channel of a calling mobile terminal, in accordance with one embodiment of the invention. Circuit 50 includes a silence control circuit 54, a modulation circuit 56, and a time division multiplexer 62. The user agent of the calling mobile terminal provides the extra information in the form of a digital sequence to modulation circuit 56 for modulation into analog signals. When silence control circuit 54 detects a silence period in the input voice, it sends a control signal to modulation circuit 56. Upon receiving the control signal, modulation circuit 56 outputs the extra information in an analog form to multiplexer 62. Multiplexer 62 time multiplexes the voice input with the extra information and sends a combined output to an ADC for transmitting to a called mobile terminal in a voice channel.

The extra information can be modulated as some patterns of frequencies in the voice band (0˜4000 Hz). For example, the Dual Tone Multi Frequency (DTMF) technique may be used to transfer 16 digits (0˜9, A˜F). Frequencies that last certain time durations (e.g., 5 ms) stand for a symbol. As an example, the combined frequencies of 1336 Hz and 770 Hz stand for 6, and the combined frequencies of 1477 Hz and 852 Hz stand for 8. If a party wants to transmit “68”, the frequencies to be added into the voice will be |1336 Hz+700 Hz| simultaneously for 5 ms and |1477 Hz+852 Hz| simultaneously for 5 ms.

FIG. 5 shows a circuit 70 for demodulating the extra information received by a called mobile terminal in the voice channel, in accordance with one embodiment of the invention. Frequency detection circuit 70 includes a frequency detection circuit 72 and a demodulation circuit 76. Frequency detection circuit 72 receives combined analog signals from a digital-to-analog converter (DAC), including both the voice and the extra information. Circuit 72 recognizes the frequencies used for representing symbols, and outputs the recognized frequencies to demodulation circuit 76 for decoding the pre-defined frequency patterns to extract the extra information. For example, if the frequency patterns |1336 Hz+700 Hz| and |1477 Hz+852 Hz| described above are recognized by frequency detection circuit 72 and output to demodulation circuit 76, demodulation circuit 76 will decode the frequency patterns and output a digital sequence of “68”.

To reduce decoding errors, the maximum time duration for the same frequency pattern is defined. For example, the same frequency that lasts longer than 50 ms is not allowed. If a calling mobile terminal sends more than 10 identical digits within a time duration over 50 ms (i.e., 10×5 ms), a disturbance frequency pattern (e.g., 11888 Hz+888 Hz|) will be added after the 10th digit. The called mobile terminal can locate the disturbance frequency pattern after the 10 identical digits. For instance, when the calling mobile terminal sends a digital sequence of 999,999,999,999 to the called mobile terminal, it will be sent as 9,999,999,999, x99, where x represents a disturbance frequency pattern. At the called mobile terminal, the received sequence 9,999,999,999, x99 will be restored to 999,999,999,999.

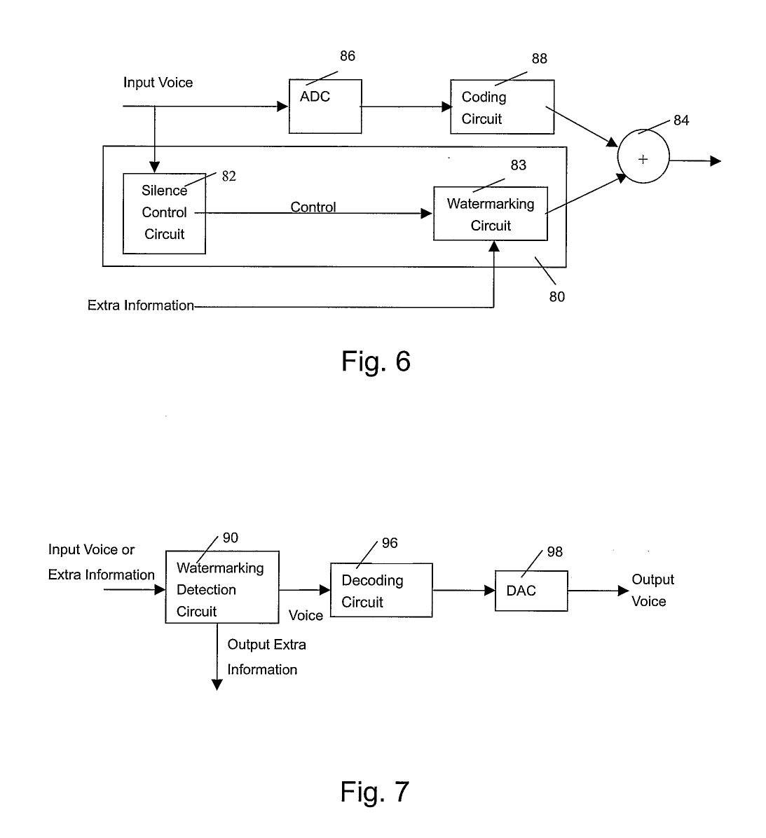

FIG. 6 shows a circuit 80 for adding the extra information as digital signals in a calling mobile terminal in accordance with one embodiment of the invention. Circuit 80 includes a silence control circuit 82 and a watermarking circuit 83. Silence control circuit 82 detects silent periods in the input voice and upon detecting a silent period, provides a control signal to watermarking circuit 83. Watermarking circuit 83 receives the extra information, including the IP address, user profile, etc. from the user agent and upon receiving the control signal, outputs the extra information to a time multiplexer 84. Watermarking circuit 83 may be implemented with a latch circuit. An ADC 86 converts the input voice into digital signals and provides the digital signals to a coding circuit 88 for coding to comply with a specific communication standard (e.g., GSM). The output from coding circuit 88 and the extra information from watermarking circuit 83 will be time multiplexed by multiplexer 84 to provide a combined output for baseband processing. In this way, the extra information is inserted in the silent periods of the input voice.

FIG. 7 shows a watermarking detection circuit 90 for extracting the extra information inserted as digital signals, in a called mobile terminal in accordance with one embodiment of the invention. Watermarking detection circuit 90 detects a pair of pre-defined digital sequences (described below in detail) from the input voice to recover the extra information. The voice will be allowed to pass through watermarking detection circuit 90 and will be output to a decoding circuit 96, which decodes the voice in accordance with a specific communication standard. A digital-to-analog (DAC) 98 converts the decoded voice into analog signals and provides them to an output device.

In FIGS. 6 and 7, a pre-defined digital sequence is used for marking the start point and end point of the extra information. For example, a digital sequence 1010101010101010 may be used for marking the start and end of the extra information. All the extra information must be enclosed within a pair of two such sequences. If the extra information or the input voice contains the same sequence pattern as the start or the end sequence, then this sequence pattern must be transformed. For example, if the extra information contains 1010101010101010, this sequence will be changed to 101010101010101110, with “11” being inserted in between the last two bits.

In addition, since DTMF signal cannot be imitated by human voice, with the watermarking technology, the extra information can be mixed with voice and exchanged in the voice channel in spite of whether there is a silence or not.

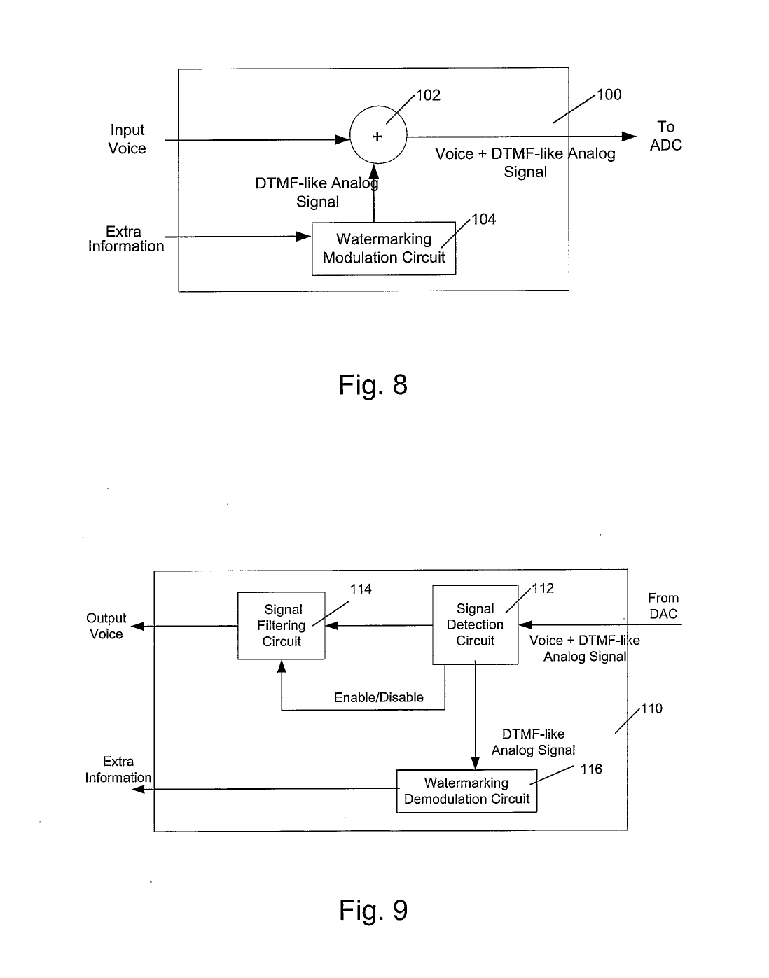

FIG. 8 shows a circuit 100 for adding the extra information as analog signals in a calling mobile terminal, in accordance with another embodiment of the invention. The circuit 100 includes a watermarking modulation circuit 104 and a multiplexer 102. The user agent of the calling mobile terminal provides the extra information in the form of a digital sequence to the watermarking modulation circuit 104 for modulation into DTMF-like analog signals. The watermarking modulation circuit 104 outputs the extra information in DTMF-like analog form to the multiplexer 102. When the user is speaking, the multiplexer 102 multiplexes the input voice with the extra information and sends a combined output to the ADC for transmitting to a called mobile terminal in the voice channel. When the user isn't speaking, the multiplexer 102 only sends the extra information to the ADC.

FIG. 9 shows a circuit 110 for demodulating the extra information added as analog signals in a called mobile terminal, in accordance with another embodiment of the invention. The circuit 110 includes a signal detection circuit 112, a signal filtering circuit 114 and a watermarking demodulation circuit 116. The signal detection circuit 112 receives the voice or combined analog signal from the DAC, including both the voice and the extra information in DTMF-like analog form. If the signal from the DAC is only the voice, the signal detection circuit 112 will disable the signal filtering circuit 114 and the voice will pass through the signal filtering circuit 114 without any modification. If the signal from the DAC is the combined analog signal, the signal detection circuit 112 will demultiplex separate DTMF-like analog signal from the combined analog signal, then feed the DTMF-like analog signal to the watermarking demodulation circuit 116. The watermarking demodulation circuit 116 will demodulate the extra information from the DTMF-like analog signal and then output the extra information in digital form. At the same time, the signal detection circuit 112 will enable the signal filtering circuit 114 and feed the combined analog signal to the signal filtering circuit 114, then the signal filtering circuit 114 will filter the DTMF-like analog signal from the combined analog signal, and output the voice signal.

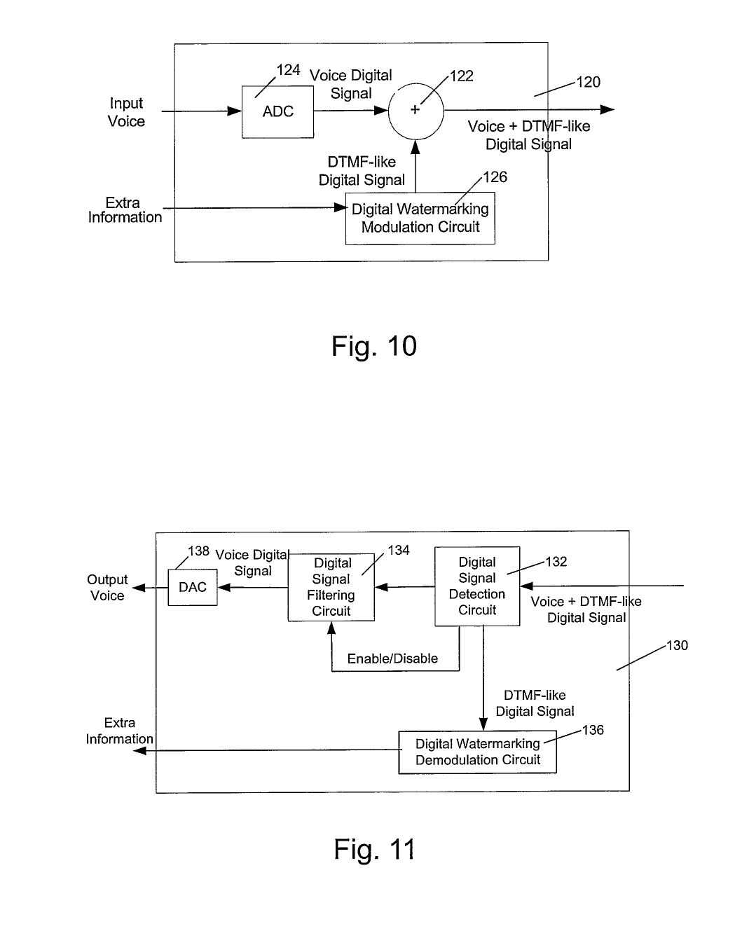

FIG. 10 shows a circuit 120 for adding the extra information as digital signals in a calling mobile terminal in accordance with another embodiment of the invention. The circuit 120 includes an ADC 124, a time multiplexer 122 and a digital watermarking modulation circuit 126. The digital watermarking modulation circuit 126 receives the extra information and outputs the extra information in DTMF-like digital signal form to the time multiplexer 122. The ADC 124 converts the input voice into digital signals. The voice digital signal from the ADC 124 and the DTMF-like digital signal from the digital watermarking modulation circuit 126 will be time multiplexed by the multiplexer 122 to provide a combined output for subsequent processing. When the user isn't speaking, the multiplexer 122 only outputs the extra information.

FIG. 11 shows a circuit 130 for extracting the extra information inserted as digital signals, in a called mobile terminal in accordance with another embodiment of the invention. The circuit 130 includes a digital signal detection circuit 132, a digital signal filtering circuit 134, a digital watermarking demodulation circuit 136 and a DAC 138. The digital signal detection circuit 132 receives the voice digital signal or combined digital signal, including both the voice digital signal and the extra information in DTMF-like digital form. If there is only the voice digital signal, the digital signal detection circuit 132 will disable the digital signal filtering circuit 134 and the voice digital signal will pass through the digital signal filtering circuit 134 without any modification. If there is the combined digital signal, the digital signal detection circuit 132 will demultiplex separate DTMF-like digital signal from the combined digital signal, then feed the DTMF-like digital signal to the digital watermarking demodulation circuit 136. The digital watermarking demodulation circuit 136 will decode the extra information from the DTMF-like digital signal and then output the extra information in digital form. At the same time, the digital signal detection circuit 132 will enable the digital signal filtering circuit 134 and feed the combined digital signal to the signal filtering circuit 134, then the signal filtering circuit 134 will filter the DTMF-like analog signal from the combined digital signal, and output the voice digital signal. The DAC 138 converts the voice digital signal into analog signal and outputs the voice to a subsequent device.

In the above, the invention has been illustrated in conjunction with a WWAN and WLAN. However, the invention may be used for roaming between any two wireless communication networks.

The present invention may be embodied as methods, communication devices, communication systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method performed by a calling mobile terminal having at least two radio interfaces respectively for a first wireless communication network and a second wireless communication network, the method comprising the steps of:
(a) detecting presence of the first and second wireless communication networks;
(b) establishing a first connection between the mobile terminal as a calling mobile terminal and a called mobile terminal via the first wireless communication network for establishing a communication session;
(c) sending extra information including a handover request together with a network address of the calling mobile terminal in the first wireless communication network to the called mobile terminal for initiating a second communication with the called mobile terminal via the second wireless communication network, if the second wireless communication network is present;
(d) receiving a response from the called mobile terminal; and
(e) if the response indicates an acceptance of the handover request, establishing the second connection with the called mobile terminal via the second wireless communication network for continuing the communication session.

2. The method of claim 1, further comprising the step of, after step (e), releasing the first connection.

3. The method of claim 1, further comprising the steps of:
during the second connection, detecting whether the calling mobile terminal is moving away from the second wireless communication network; and
if the calling mobile terminal is moving away from the second wireless communication network, establishing a third connection with the called mobile terminal via the first wireless communication network.

4. The method of claim 1, further comprising a step of:
detecting a preferred radio interface for communication based on a user profile in the calling mobile terminal;
wherein step (c) is performed if the preferred radio interface is for the second wireless communication network and the second wireless communication network is present.

5. The method of claim 1, further comprising a step of:
accepting a fourth connection with another mobile terminal via the second wireless communication network, as a receiving mobile terminal;
during the fourth connection, detecting whether the receiving mobile terminal is moving away from the second wireless communication network; and
if the receiving mobile terminal is moving away from the second wireless communication network, sending a handover request to the other mobile terminal for initiating a fifth connection with the other mobile terminal via the first wireless communication network.

6. The method of claim 1, wherein in step (c) the extra information is sent to the called mobile terminal using a watermarking technique.

7. The method of claim 6, wherein the extra information is sent to the called mobile terminal via a voice channel between the calling and called mobile terminals.

8. The method of claim 7, wherein the extra information is inserted in the silent durations of input voice.

9. The method of claim 8, wherein step (c) comprises steps of:
receiving input voice and detecting silent periods in the input voice;
outputting a control signal when detecting a silent period;
modulating the extra information into modulated analog signals if receiving the control signal; and
multiplexing the modulated analog signals into the silent periods of the input voice.

10. The method of claim 7, wherein step (c) comprises steps of:
receiving the extra information and outputting the extra information in DTMF-like analog signal form; and
multiplexing the extra information in DTMF-like analog signal form with input voice and outputting the combined analog signals.

11. The method of claim 7, wherein step (c) comprises steps of:
receiving the extra information and outputting the extra information in DTMF-like digital signal form; and
multiplexing the extra information in DTMF-like digital signal form with digitized input voice and outputting the combined digital signals.

12. A method performed by a called mobile terminal having at least two radio interfaces respectively for a first wireless communication network and a second wireless communication network, the method comprising the steps of:
(a) accepting a first connection with a calling mobile terminal via the first wireless communication network;
(b) during the first connection, detecting whether the second wireless communication network is present, if receiving extra information including a handover request together with a network address from the calling mobile terminal for initiating a second connection with the called mobile terminal via the second wireless communication network;
(c) sending a response to the calling mobile terminal with an acceptance of the handover request if the second wireless communication network is present; and
(d) accepting the second connection with the calling mobile terminal.

13. The method of claim 12, further comprising a step of, before step (c):
verifying whether a preferred radio interface for communication based on a user profile in the called mobile terminal is for the second wireless communication network;
wherein step (c) is performed if the preferred radio interface of the called mobile terminal is for the second wireless communication network.

14. The method of claim 12, further comprising the step of, after step (d), releasing the first connection.

15. The method of claim 12, wherein in step (b) the extra information received by the called mobile terminal uses a watermarking technique.

16. The method of claim 15, wherein the extra information is received by the called mobile terminal via a voice channel between the calling and called mobile terminals.

17. The method of claim 15, wherein the extra information received by the called mobile terminal is in a DTMF-like analog signal form and combined with a voice.

18. The method of claim 17, wherein step (b) comprises steps of:
receiving the voice or the combined analog signals, if only the voice, outputting the voice and if the combined analog signal, demultiplexing separate DTMF-like analog signal from the combined analog signal and outputting the DTMF-like analog signal and the combined analog signal;
demodulating the extra information from the DTMF-like analog signal and outputting the extra information; and
filtering the DTMF-like analog signal from the combined analog signal and outputting the voice.

19. The method of claim 15, wherein the extra information received by the called mobile terminal is in a DTMF-like digital signal form and combined with a digitized voice.

20. The method of claim 19, wherein step (b) comprises steps of:
receiving the digitized voice or the combined digital signals, if only the digitized voice, outputting the digitized voice, and if the combined digital signal, demultiplexing separate DTMF-like digital signal from the combined digital signal and outputting the DTMF-like digital signal and the combined digital signals;
translating the DTMF-like digital signal into the extra information and outputting the extra information; and
filtering the DTMF-like digital signal from the combined digital signal and outputting the digitized voice.

21. The method of claim 12, wherein the first wireless communication network is wireless wide area network (WWAN) and the second wireless communication network is wireless local area network (WLAN).

22. A circuit for a mobile terminal communicating in a first and second wireless communication networks, comprising:
means for detecting presence of the first wireless communication networks;
means for detecting presence of the second wireless communication networks;
means for establishing a first connection between the mobile terminal as a calling mobile terminal and a called mobile terminal via a first wireless communication network;
means for sending extra information including a handover request together with a network address of the calling mobile terminal in the first wireless communication network to the called mobile terminal for initiating a second connection with the called mobile terminal via the second wireless communication network, if the second wireless communication network is present;
means for receiving a response from the called mobile terminal; and
means for establishing the second connection with the called mobile terminal via the second wireless communication network, the second connection establishing means establishing the second connection if the response indicates an acceptance of the handover request.

23. A mobile terminal comprising at least two radio interfaces and the circuit as claimed in claim 22.

24. A circuit for a mobile terminal communicating in a first and second wireless communication networks, comprising:
means for accepting a first connection with a calling mobile terminal via the first wireless communication network, as a called terminal;
means for detecting whether the second wireless communication network is present during the first connection, if receiving a handover request from the calling mobile terminal for initiating a second connection with the called mobile terminal via the second wireless communication network;
means for sending a response to the calling mobile terminal with an acceptance of the handover request if the second wireless communication network is present; and
means for accepting the second connection with the calling mobile terminal.

25. A mobile terminal comprising at least two radio interfaces and the circuit as claimed in claim 24.

26. A computer program product for handover of a calling mobile terminal between a first wireless communication network and a second wireless communication network, comprising:
computer readable program code for detecting presence of the first and second wireless communication networks;
computer readable program code for establishing a first connection between the mobile terminal as a calling mobile terminal and a called mobile terminal via the first wireless communication network for establishing a communication session;
computer readable program code for sending extra information including a handover request together with a network address of the calling mobile terminal in the first wireless communication network to the called mobile terminal for initiating a second communication with the called mobile terminal via the second wireless communication network, if the second wireless communication network is present;
computer readable program code for receiving a response from the called mobile terminal; and
computer readable program code for establishing the second connection with the called mobile terminal via the second wireless communication network for continuing the communication session, if the response indicates an acceptance of the handover request.

27. A computer readable program medium carrying the computer program product of claim 25.

28. A computer device comprising the computer readable program medium of claim 27.

29. A computer program product for handover of a called mobile terminal between a first wireless communication network and a second wireless communication network, comprising:
computer readable program code for accepting a first connection with a calling mobile terminal via the first wireless communication network;
computer readable program code for during the first connection, detecting whether the second wireless communication network is present, if receiving extra information including a handover request together with a network address from the calling mobile terminal for initiating a second connection with the called mobile terminal via the second wireless communication network;
computer readable program code for sending a response to the calling mobile terminal with an acceptance of the handover request if the second wireless communication network is present; and
computer readable program code for accepting the second connection with the calling mobile terminal.

30. A computer readable program medium carrying the computer program product of claim 29.

31. A computer device comprising the computer readable program medium of claim 30.
